(19) United States
(12) Patent Application Publication
(10) Pub. No.: US 2013/0343543 A1
(43) Pub. Date: Dec. 26, 2013

(54) USER EXPERIENCE AND METHOD FOR PROMOTING A LOW-ASSURANCE CALL TO A HIGH-ASSURANCE CALL ON A CALLING DEVICE

(71) Applicant: Mocana Corporation, San Francisco, CA (US)

(72) Inventors: James BLAISDELL, Novato, CA (US); Yingxian WANG, Palo Alto, CA (US); Soo-Fei CHEW, Castro Valley, CA (US)

(21) Appl. No.: 13/926,753

(22) Filed: Jun. 25, 2013

Related U.S. Application Data
(60) Provisional application No. 61/663,838, filed on Jun. 25, 2012.

(51) Int. Cl. H04W 12/04

(52) U.S. Cl. CPC H04W 12/04
USPC 380/270

(57) ABSTRACT

A low-assurance call on a mobile device to another device may be promoted to a high-assurance call using a user interface. The participants during the call do not need to hang up and start a new high-assurance call. A caller can swipe an icon up a slider, for example, and start a process of promoting the call. The initial low assurance call using SIP servers is terminated but this is transparent to the callers. Once the swipe is performed, a DTLS negotiation is performed between the devices. During this DTLS handshake, which is done directly between the device without involvement of the SIP servers, a key is exchanged. Only the calling devices are aware of this key which is used to encrypt media during the call. Screens on the calling devices show that the call is now high-assurance and security details of the call may also be displayed.

### CROSS-REFERENCE TO RELATED APPLICATIONS

This application claims priority under 35 U.S.C. §119(e) to pending U.S. Provisional Patent Application No. 61/663,838, filed Jun. 25, 2012, entitled “USER EXPERIENCE AND METHOD FOR PROMOTING A LOW-ASSURANCE CALL TO A HIGH-ASSURANCE CALL ON A CALLING DEVICE”, which is hereby incorporated by reference in its entirety.

### BACKGROUND OF THE INVENTION

1. Field of the Invention

The present invention relates to mobile devices, such as smart phones, tablets, and wearable sensors. More specifically, it relates to software for promoting a call having a first security level, such as a low-assurance call to a call having a second security level, such as a high-assurance call, between devices.

2. Description of the Related Art

Making phone calls over the Internet has been popular for many years now. These VoIP (“voice over IP”) calls allow callers to make inexpensive or often free calls anywhere in the world over the Internet. VoIP calls may have different levels of security with respect to preventing third-parties from listening to a call or otherwise tampering with a call. One level is referred to as low assurance. These types of VoIP calls are the most common today. Low-assurance calls provide a level of security for the call that is acceptable in the vast majority of cases. Another level is known as high assurance. This is a higher level of security for a VoIP call for preventing outside parties from listening to the content of a call. High-assurance calls may be used to protect calls where highly confidential or secret information may be exchanged or simply when one or all of the callers want a higher degree of certainty that their call is kept private and not tampered with. A situation may arise where a call that starts as a low-assurance call may, as deemed by one or more of the callers, need to be promoted to a high-assurance call.

It would be desirable to have a mechanism on a calling device, such as a cell phone, tablet, PC, or wearable sensor to enable a VoIP caller to promote a call from a low-assurance to a high-assurance call during the call without having to make a new call. Further, it would be desirable to allow a caller to do so via an intuitive and simple user experience. It would be desirable to be able to do so with minimal software on the mobile device being used to transition to the high-assurance call.

### SUMMARY OF THE INVENTION

In one aspect of the invention, a method of promoting a low assurance call to a high assurance call is described. The transition to the high assurance call is done without the callers having to hang up and make a new call. It can be done while on the low assurance call by a caller performing an action via the user interface on the phone or device. For example, a caller may swipe an icon from one position (indicating a low assurance call) to a second position (indicating a high assurance call). When a caller does this during the initial call, a negotiation phase begins directly between the first and second devices. The initial low assurance call is terminated, but this is done transparently to the callers. Thus, unbeknownst to the callers, the first call is actually terminated and a security negotiation phase begins between the two devices to implement the high assurance call.

A display on one or both of the devices tells the callers that this negotiation phase is occurring. In one embodiment, the negotiation or handshake is based on the Datagram Transport Layer Security (DTLS) protocol. During this handshake a key is generated using only data on the calling devices; no external devices are involved in creating this key and this key is not given or known to any other devices (e.g., proxy servers, SIP servers, and the like). The key is used to encrypt media comprising the high assurance call between the devices. In one embodiment, the SIP servers used in the low assurance call are informed that the low assurance call was terminated at the time when the high assurance call is terminated.

### BRIEF DESCRIPTION OF THE DRAWINGS

References are made to the accompanying drawings, which form a part of the description and in which are shown, by way of illustration, specific embodiments of the present invention:

FIG. 1 is a screen shot of a display on a mobile calling device showing a low assurance call in accordance with one embodiment;

FIG. 2 is a screen shot of a display showing a high assurance call in accordance with one embodiment;

FIG. 3 is a screen shot of a display of a high assurance call and security-related details of the call in accordance with one embodiment;

FIG. 4 is a screen shot of a display showing the negotiation phase of transitioning to a high assurance call in accordance with one embodiment;

FIG. 5 is a flow diagram of a process of promoting a low assurance call to a high assurance call in accordance with one embodiment; and

FIGS. 6A and 6B illustrate a computing device 600 suitable for implementing embodiments of the present invention.

### DETAILED DESCRIPTION OF THE INVENTION

Example embodiments of promoting a low assurance call to a high assurance call during the initial call via a simple and intuitive user experience are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

High-assurance calls may be used to protect calls where highly confidential or secret information may be exchanged or simply when one or all of the callers wants a higher degree of certainty that their call is kept private and not tampered with. A situation may arise where a call that starts as a low-assurance call may, as deemed by one or more of the callers, need to be promoted to a high-assurance call. For example, one of the callers may need to disclose highly confidential information on the call that was not anticipated at the beginning of the call. As is known in the art, a low assurance call is based on the IETF standard and SDES (“Session Description Protocol Security Description”) for media streams (voice, video, data, etc.). In low assurance calls, the Session Initiation Protocol (SIP) server sends each side of the call an encryption key. This key is sent to the other party via an SIP message to either invite a call or respond to a call. Software on the calling devices selects a security profile. Once the exchange of keys is complete, each side knows which security profile to use via Secure Real-time Transport Protocol (SRTP). They can then begin their low-assurance phone call using the encryption keys and agreed-upon profiles.

Such VoIP calls are referred to as low assurance because the encryption keys are exchanged over the Internet via intermediate SIP proxy servers. While generally safe and such nodes are essentially trustworthy, these proxy servers pose security risks where it is possible that the encryption keys can be intercepted, and the media decrypted. Another reason it is considered low assurance is that each key is generated solely by the SIP server with no contribution from the other calling devices. This typically makes the encryption key weaker or easier to decrypt. However, such low assurance calls generally are secure and do prevent others from listening or eavesdropping on the call.

High-assurance calls are based on IETF standards but take extra pre-cautions to ensure that a VoIP call is secure and cannot be listened to as compared to low-assurance calls. There are two phases in high-assurance calls. The first is establishing keys using DTLS, a protocol where two parties can exchange messages (perform a handshake) and establish encryption keys. The keys are more secure because they are derived from contributions by both callers, where the callers are mutually authenticated. The keys are exchanged in an end-to-end manner without intermediaries, such as SIP proxy servers or other nodes in between. The keys are derived from information from both callers and, once created, are not transmitted over any communication channel. That is, the keys are not transmitted or exchanged, thereby removing the possibility of the keys being intercepted and decrypted. The SRTP profile is also selected.

Embodiments of the present invention enable a caller to go from a low-assurance call to a high-assurance call while currently on the low-assurance call. In one embodiment, the low assurance call is established between callers using the processes described above. The caller's calling devices has software on it that allows the caller to promote the call to a high assurance call. In one embodiment, this software implements a slider with an icon displayed on a smart phone display which the caller touches and slides vertically up. The icon on the slider may represent security, such an image of a lock, and be of a specific color, such as blue. When the caller slides the icon up the slider and the icon remains at the top of the slider (i.e., does not snap back down) and changes color, the caller knows that the call has been promoted to a high security or high assurance call. If the call does not get promoted to high assurance, the icon either snaps back to the bottom of the slider or remains at the top but does not change color. These can act as clear visual cues to the caller that the call was or was not promoted. In addition, if the call is successfully promoted to high assurance, other data can appear on the smart phone, as described below, such as profile data and any other suitable information that would be displayed if the caller had initially started a high assurance call.

The software for promoting the call resides on both (or all) calling devices. Thus, if two callers are making a low assurance call with each other and one wants to make the call high assurance during the call the software for doing so resides on both calling devices. In one embodiment, by sliding the icon up the slider on either device, the “call promotion” software on that device begins coordinating with the same software on the other device. As such, sliding the call promotion icon up the sliding bar on either phone effects operations on both phones.

When a caller slides the icon during a low assurance call, first, that call is terminated. In other embodiments, it may be suspended. Second, the “call promotion” software on both phones automatically initiates a new call between the same calling devices that is high assurance. During this “initiation” time period, the callers cannot talk to each other since there is no session or call active at this time. During the new call initiation phase, the steps described above for establishing a high assurance call, such as negotiating new encryption keys and establishing profiles, take place. Instead of callers initiating the call, the call is started by coordination of “call promotion” software on both devices. The software is able to start the high assurance call between the two or more callers. If the new call is successfully established, the icon stays at the top of the slider and the color of the icon changes. Other visual cues and user experiences may be used.

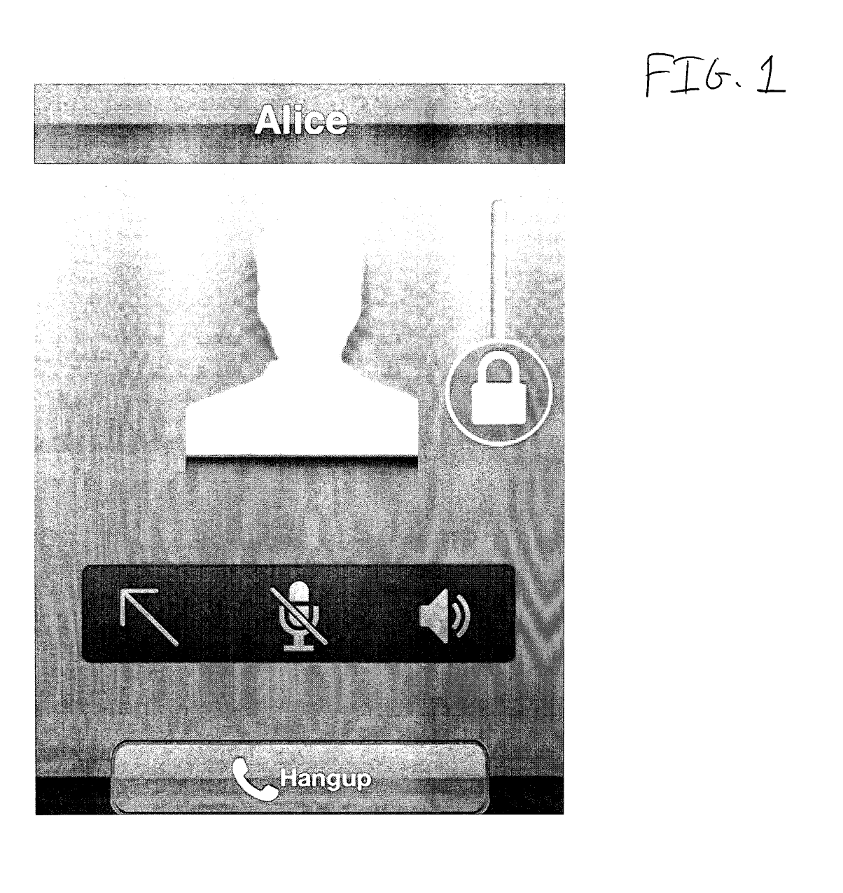

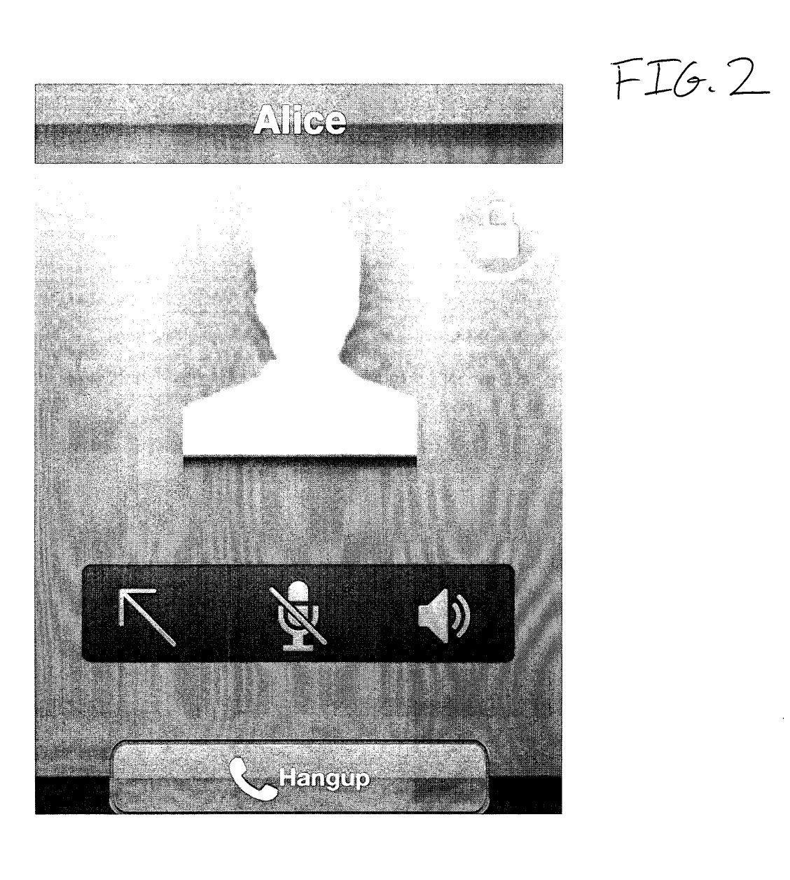

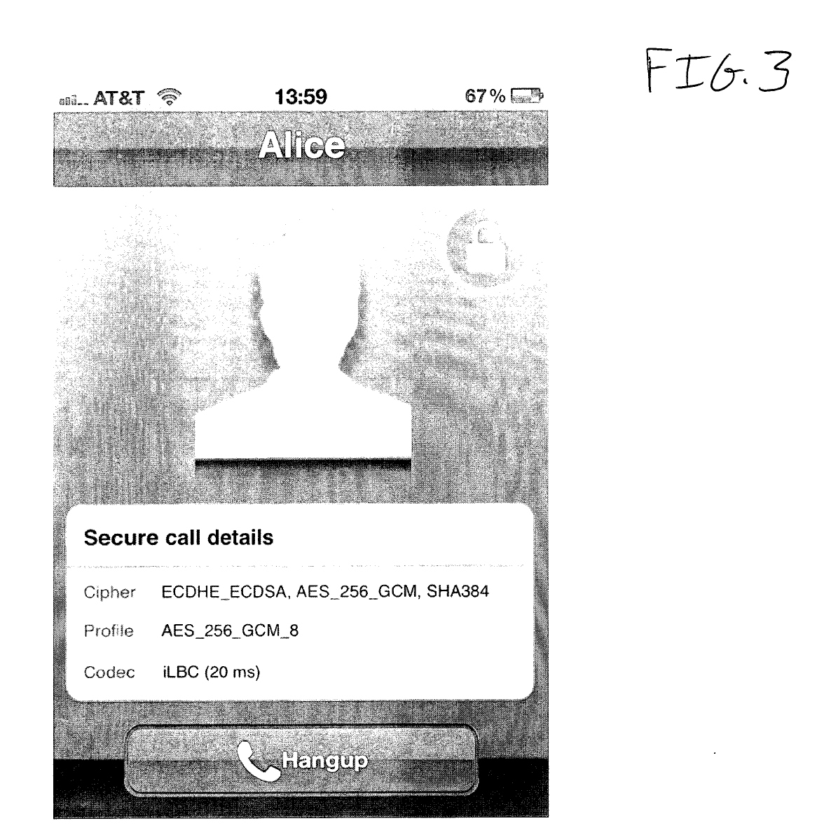

In one embodiment, a call starts as a low assurance call. This is shown in FIG. 1 as a screen shot showing a call being made by Bob (name not shown) to Alice. The blue lock icon on the left is at the bottom of a vertical slider indicating a low assurance call. When the caller, Bob, slides the icon up the vertical slider, the call starts a security negotiation phase with Alice's device. In one embodiment, the security negotiation may be implemented as a Datagram Transport Layer Security (DTLS) handshake between the two callers. It is during this handshake phase that a security key is created using input from only the devices on the call (in this case two) and shared between the devices. No other entity or devices, such as a proxy server, knows the key. FIG. 2 is a similar screen shot after the caller, Bob, slides the lock icon up the vertical slider while still on the call. As explained below, when Bob slides the icon up (and the icon stays at the top), the initial low assurance call is terminated. When the call transitions to a high assurance call, the icon may change visually (e.g., it may become a different color and have a different border). Once the call has transitioned to a high-assurance call, the caller may choose to show the secure, high-assurance call details, such as cipher, profile, and codec information. This is shown in FIG. 3. In sum, a call starts as low-assurance, the caller swipes up to high-assurance, a negotiation phase begins, and once completed, the new call is high-assurance as indicated on the caller display.

As described above, the call begins as a low-assurance call. Callers Bob and Alice are registered with one or more SIP servers. In one embodiment, this may be done using the callers' e-mail addresses. In order to have a low or high-assurance call, participants in the call must be registered with an SIP server. If there is more than one SIP server, then the servers must be in communication with each other. If Bob initiates a call to Alice, Bob, already registered with an SIP server, sends an invite for a call to the server. The server may first check to ensure that Alice is registered. Assuming she is, the SIP server(s) will send information to Bob on how to contact Alice. In most cases, this will be an IP address. At this stage, Bob is able to contact Alice using this address. The SIP server(s) will also send a key to Bob and Alice. This key is used by the participants in the call to encrypt the media comprising the content of the call (voice, video, data, etc.) between Bob and Alice. This encryption of the media is what essentially makes the call secure in the low-assurance category. The SIP server knows what the key is since it generated the key and supplied to the callers.

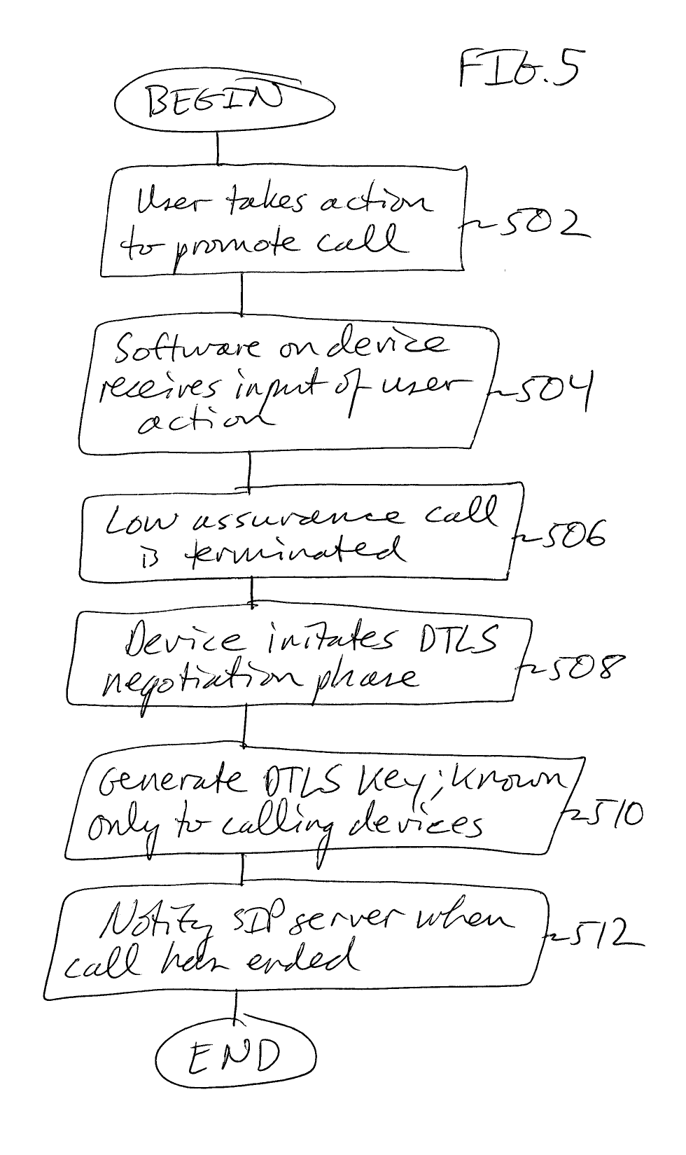

During the low-assurance call, Bob or Alice may want to transition to a high-assurance call. As noted above, the screen that Bob may see is shown in FIG. 1. FIG. 5 is a flow diagram of a process of promoting an existing low assurance call to high assurance. At step 502 Bob swipes the lock icon up the vertical bar. A software module on the mobile device causes the display of the vertical bar and lock icon on the device display. In other embodiments, the software may also cause the display of the other elements, such as the other icons, the image of the person being called (in this case Alice), and the like. At step 504, the software module receives input that the user (i.e., caller) has performed this swipe. In other embodiments, the user may perform another action with the device or provided stimulus through another means, such as tapping a button or icon or moving the phone in a certain way. Regardless of how the user performs the action or provides stimulus, the module receives input that the call should now transition to high assurance.

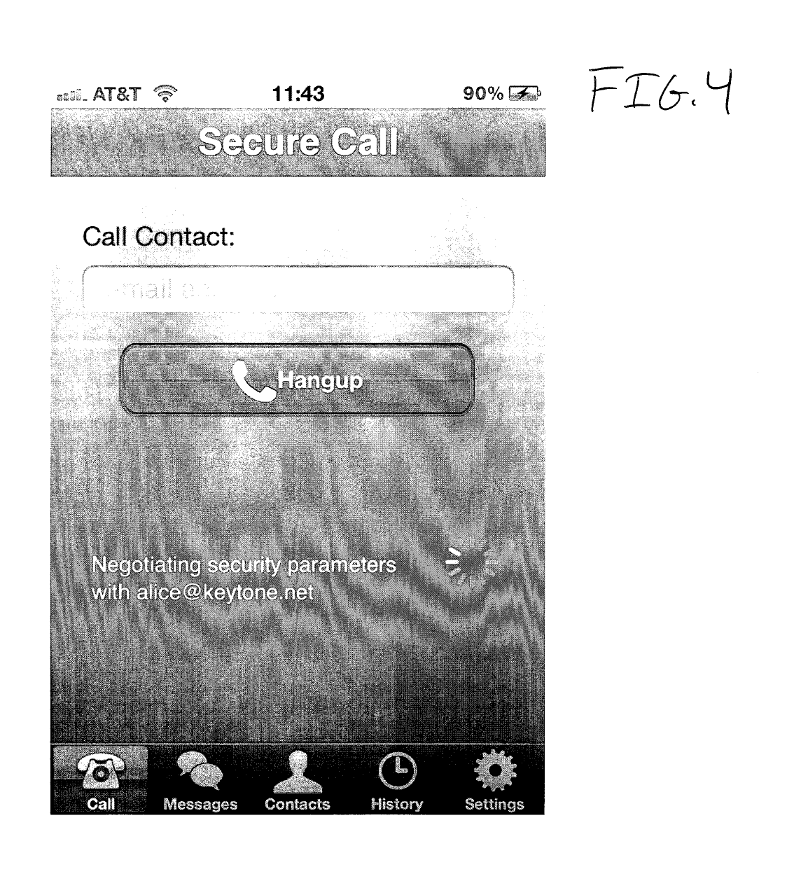

At step 506 the low-assurance call is terminated. In one embodiment, the SIP servers are not informed that the call is being terminated at this time. At step 508, in one embodiment, a DTLS negotiation phase begins. It is initiated by the software module on the caller's device. While the DTLS handshake process takes place at step 508 with the other caller's device (Alice's device), each caller may see the screen shown in FIG. 4 indicating that the negotiation phase of a secure call is being performed. For example, the screen may say “negotiating security parameters with alice@keytone.net” and also provide the caller (Bob) with the option of ending the call.

Thus, a DTLS handshake is performed directly between Bob and Alice. SIP servers are not involved. As noted, the initial low-assurance call is terminated at step 506. One of the important aspects of the handshake phase between the devices, is the generation of a key under the DTLS protocol that is known only to the two devices. The key is generated at step 510 and is shared only between the two devices. At this stage the callers will see a screen similar to that shown in FIG. 3 where the lock icon is at the top of the slider indicating a high-assurance call. The new key is used to encrypt the media comprising the call. A caller may select to display the new secure call details as shown in FIG. 3. At step 512, when the callers are done with the call, the software module on the mobile devices informs the SIP server(s) (from the low assurance call) that the call has terminated. In one embodiment, this is done when the high-assurance, DTLS-based call is finished. In another embodiment, this is done when the low assurance call is terminated at step 506.

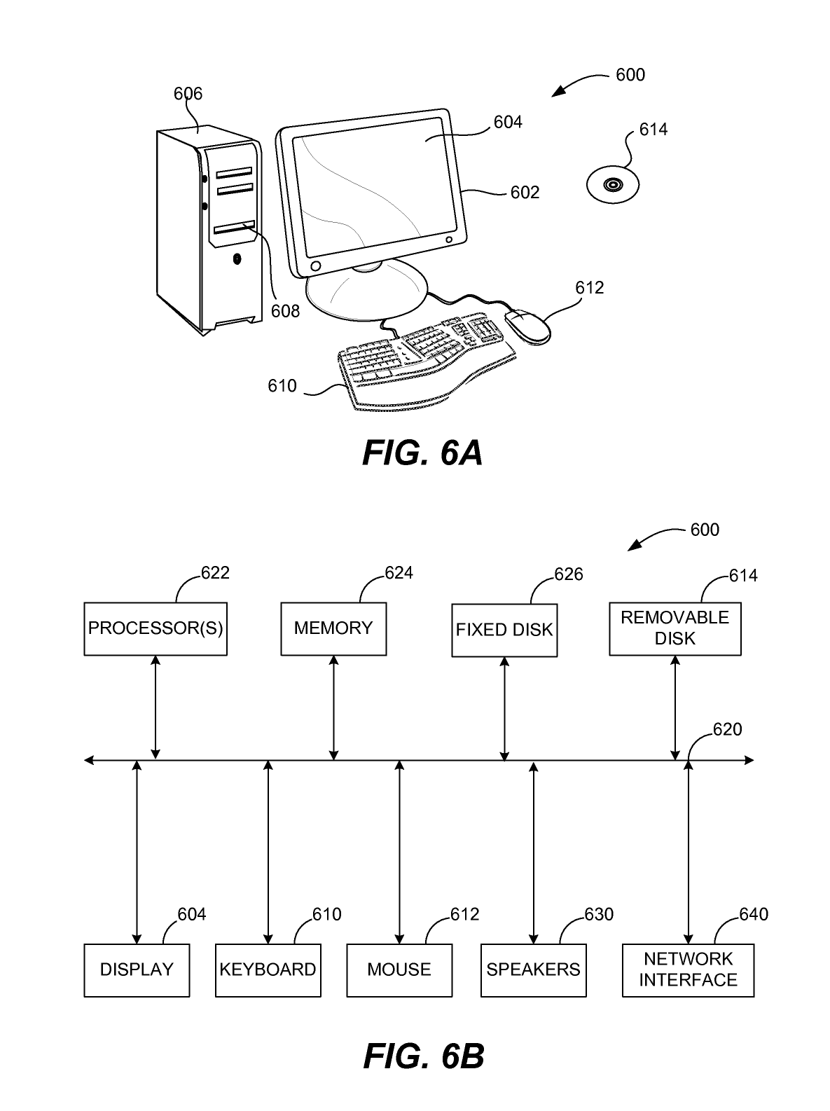

FIGS. 6A and 6B illustrate a computing system 600 suitable for implementing embodiments of the present invention. FIG. 6A shows one possible physical form of the computing system. Of course, the computing system may have many physical forms including an integrated circuit, a printed circuit board, a mobile device, such as a smartphone, tablet, or wearable sensor (e.g., a watch), a personal computer or a super computer. Computing system 600 includes a monitor 602, a display 604, a housing 606, a disk drive 608, a keyboard 610 and a mouse 612. Disk 614 is a computer-readable medium used to transfer data to and from computer system 600.

FIG. 6B is an example of a block diagram for computing system 600. Attached to system bus 620 are a wide variety of subsystems. Processor(s) 622 (also referred to as central processing units, or CPUs) are coupled to storage devices including memory 624. Memory 624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 626 is also coupled bi-directionally to CPU 622; it provides additional data storage capacity and may also include any of the computer-readable media described below. Fixed disk 626 may be used to store programs, data and the like and is typically a secondary storage medium (such as a hard disk) that is slower than primary storage. It will be appreciated that the information retained within fixed disk 626, may, in appropriate cases, be incorporated in standard fashion as virtual memory in memory 624. Removable disk 614 may take the form of any of the computer-readable media described below.

CPU 622 is also coupled to a variety of input/output devices such as display 604, keyboard 610, mouse 612 and speakers 630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 622 optionally may be coupled to another computer or telecommunications network using network interface 640. With such a network interface, it is contemplated that the CPU might receive information from the network, or might output information to the network in the course of performing the above-described method steps. Furthermore, method embodiments of the present invention may execute solely upon CPU 622 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What is claimed is:

1. A method of promoting a first-level security call to a second-level security call, the method comprising:
executing the first-level security call between a first mobile device and a second device;
receiving input that the first-level security call is being promoted to a second-level security call;
terminating the first-level security call on the first device and on the second device;
initiating a security negotiation directly between the first device and the second device, wherein only the first device and the second device are involved in the negotiation;
generating a key during the security negotiation, wherein the key is only known to the first device and to the second device; and
initiating the second-level security call using the key to encrypt media in the second-level security call, wherein no external computing devices are utilized.

2. A method as recited in claim 1 wherein said input results from a caller performing an action on a display of the first device or on the second device.

3. A method as recited in claim 1 wherein the security negotiation is based on Datagram Transport Layer Security (DTLS).

4. A method as recited in claim 1 further comprising:
notifying a Session Initiation Protocol (SIP) server when the first-level security call is terminated.

5. A method as recited in claim 1 wherein initiating a security negotiation further comprises:
displaying on the first device a message that security parameters are being negotiated.

6. A method as recited in claim 1 wherein initiating the second-level security call further comprises:
changing an icon on the first device and on the second device indicating that the call is second-level security.

7. A method as recited in claim 1 further comprising:
displaying details of the second-level security call on the first device and on the second device.

8. A method as recited in claim 1 wherein the first-level security call is a low assurance call and the second-level security call is a high assurance call.

9. A device for making a voice-over-IP call, the device comprising:
means for executing a first-level security call to a second device;
means for receiving input that the first-level security call is being promoted to a second-level security call, said input resulting from a user action on the device;
means for terminating the first-level security call with the second device;
means for initiating a security negotiation directly with the second device, wherein only the device and the second device are involved in the negotiation;
means for generating a key during the security negotiation, wherein the key is only known to the device and to the second device; and
means for initiating the second-level security call using the key to encrypt media in the second-level security call, wherein no external computing devices are utilized.
